(19) United States
(12) Patent Application Publication
(10) Pub. No.: US 2026/0200693 A1
(43) Pub. Date: Jul. 16, 2026

(54) GLASS FIBER WINDING METHOD, GLASS FIBER WINDING DEVICE, AND GLASS FIBER WINDING MACHINE

(71) Applicant: Dietze & Schell Maschinenfabrik GmbH & Co. KG, Coburg (DE)

(72) Inventors: Johannes BOUILLON, Coburg (DE); Björn FRÖTSCHNER, Lautertal (DE); Patric ELSNER, Eisfeld (DE); René HACK, Coburg (DE)

(21) Appl. No.: 19/133,634

(22) PCT Filed: Nov. 30, 2023
(86) PCT No.: PCT/EP2023/083761

§ 371 Date: May 28, 2025

(30) Foreign Application Priority Data
Nov. 30, 2022 (DE) 10 2022 131 742.0

(51) Int. Cl. B65H 67/048; B29C 70/30; B29C 70/54; B29K 309/08; B65H 65/00

(52) U.S. Cl. CPC B65H 67/048; B65H 65/00; B29C 70/30; B29C 70/54; B29K 2309/08; B65H 2701/312

(57) ABSTRACT

A glass fiber winding method for filaments with a thickness of more than 300 tex, preferably for glass fiber direct rovings, comprises at least one filament transfer step, in which the filament that is to be wound is transferred from a winding spool unit onto a further winding spool unit or vice versa, wherein the winding spool units are operated with different outer-circumferential speeds and/or with different revolution speeds at least during the transfer of the filament between the winding spool units, wherein a ratio of the outer-circumferential speeds and/or of the revolution speeds of the winding spool units is selected in such a way that, when the filament is brought into contact with a free winding spool unit of the winding spool units which before the transfer of the filament is free of the filament, the filament forms a loop the arc of which points towards an entry point of the free winding spool unit, at which the incoming filament meets the free winding spool unit, wherein the formation of the loop is assisted by a blowing device and/or by a spraying device, wherein the blowing device and/or the spraying device are/is oriented in such a way that an output direction of a blowing medium and/or of a spraying medium points at least substantially to the open side of the loop and/or points into the loop.

### CROSS-REFERENCE TO RELATED APPLICATION

This patent application is a U.S. national stage application of international patent application PCT/EP 2023/083761, filed on Nov. 30, 2023, which is based on and claims priority to German patent application DE 10 2022 131 742.0, filed on Nov. 30, 2022, the contents of which are incorporated herein by reference.

### Prior Art

The invention concerns a glass fiber winding method, a glass fiber winding device and a glass fiber winding machine.

Glass fiber winders are already known.

From DE 12 92 779 A and DE 100 61 350A1 , filament winding methods for filaments with a thickness of more than 300 tex are already known, wherein the already-known filament winding methods comprise at least one filament transfer step, in which the filament wound onto a winding spool unit and to be wound onto a further winding spool unit is transferred from the winding spool unit to the further winding spool unit and/or vice versa, wherein the winding spool units are operated with different outer-circumferential speeds and/or with different rotation speeds at least during the transfer of the filament between the winding spool units.

Furthermore, from DE 20 2004 004 639U1, EP 1 028 908A1, U.S. Pat. No. 4,339,089 A, DE 10 2020 006 536 A1 und U.S. Pat. No. 5,485,967 A glass fiber winding methods are already known, in which in at least one filament transfer step, in which the filament wound onto a winding spool unit and to be wound onto a further winding spool unit is transferred from the winding spool unit to the further winding spool unit and/or vice versa.

The objective of the invention is in particular to provide a generic glass fiber winding method, a generic glass fiber winding device and/or a generic glass fiber winding machine, with advantageous properties with regard to a filament transfer between winding spool units during the winding of the filament. The objective is achieved according to the invention.

### ADVANTAGES OF THE INVENTION

The invention is based on a glass fiber winding method for filaments with a thickness of more than 300 tex, preferably for glass fiber direct rovings, with at least one filament transfer step, in which the filament wound onto a winding spool unit and to be wound onto a further winding spool unit is transferred from the winding spool unit, in particular a first winding spool unit, onto the further winding spool unit, in particular a second winding spool unit, and/or vice versa, wherein-at least during the transfer of the filament between the winding spool units-the winding spool units are operated with, in particular significantly, different, in particular radial, outer-circumferential speeds and/or with, in particular significantly, different revolution speeds, wherein a ratio of the outer-circumferential speeds and/or of the revolution speeds of the winding spool units is selected such that when the filament is brought into contact with a free winding spool unit of the winding spool units which before the transfer of the filament is free of the filament, the filament forms a loop whose arc points towards an entry point of the free winding spool unit, at which the incoming filament meets the free winding spool unit.

It is proposed that the formation of the loop is supported by a blowing device and/or by a spraying device, the blowing device and/or the spraying device being oriented in such a way that an output direction of a blowing medium and/or of a spraying medium points at least substantially to the open side of the loop and/or points into the loop. The filament winding method according to the invention advantageously allows achieving an optimized filament transfer between the two winding spool units. Advantageously, substantial independence from the necessity of operator interventions is achievable. Advantageously, a production of a large number of filament winding packages can be achieved in a simple and/or efficient manner, preferably with a high piece number speed. Advantageously, simple, rapid and/or operator-independent filament transfer is enabled. Advantageously, this allows capturing and/or clamping of the filament on the free winding spool unit, in particular by the incoming filament, so that the winding of the filament onto the free winding spool unit starts automatically. It is advantageously possible to achieve high reliability of the filament transfer. Advantageously, the capturing and/or clamping of the loop by the incoming filament can be accelerated.

In particular, the filament is designed as a glass fiber. In particular, the filament winding method is carried out directly after or in a temporal context of the production of the filaments, in particular glass fibers. It may herein happen that the filaments, in particular glass fibers, that are to be wound are still moist during the winding and/or during execution of the filament transfer step. In particular, in the filament transfer step the filament contacts both winding coil units at least temporarily. In particular, the filament is in the filament transfer step transferred from a winding spool unit, which already carries a plurality of filament windings, to a further winding spool unit, which is initially free of filament windings, in particular in such a way that after the filament transfer step no further filament windings are added to the winding coil unit, whereas further filament windings are added to the further winding coil unit. In particular, the filament winding method is configured for filaments having a thickness of more than 300 tex; however, an application of the filament winding method according to the invention for filaments having a thickness of less than 300 tex is thereby not excluded and/or is likewise possible.

In particular, the winding coil units are rotatable, preferably rotationally driven, for example by a respective separate drive or by a shared drive unit. Preferably, the rotation speeds, revolution speeds and/or outer-circumferential speeds of the winding spool units are adjustable. In particular, the rotation speeds, revolution speeds and/or outer-circumferential speeds of the winding spool units are adjustable separately from one another. It is for example possible to reduce or increase, preferably to slow down or accelerate, the rotation speed of each winding spool unit separately. The winding spool units are preferably realized cylindrically. It is conceivable that several separate, for example two, filament winding packages are produced per winding spool unit. In this case, the several filament winding packages are arranged side by side on the winding spool unit in the axial direction of the winding spool unit. In particular, the two winding spool units are realized at least substantially identically to one another. It is conceivable that the filaments are wound directly onto a surface of the winding spool units; however, preferably per each filament winding package a winding tube is applied to, e.g. put upon, the winding spool units, onto which winding tube the respective filament is then wound. In particular, the filament is fed to the winding spool units via a filament-feeding device. The filament-feeding device is in particular configured, during the feeding of the filament, to move the filament back and forth parallel to the axial direction of the winding spool(s). Herein the deflection of the back-and-forth movement of the filament in particular corresponds to the desired longitudinal extent of a filament winding package. The filament has a thickness of more than 300 tex, preferably of more than 900 tex. Preferentially, the filament is realized as a direct roving, which in particular has a thickness of 900 tex to 10,000 tex. Herein a “tex” is in particular to mean a weight in grams per 10,000 m of filament. In particular, such filaments, in particular direct rovings, are not suitable for a direct “tube-to-tube filament transfer”, as is used in the so-called spinning-cake method. This in particular functions only for filaments having thicknesses below 300 tex. In particular, the revolution speeds of the winding spool units differ by at least 1%, preferably by at least 2%. Larger differences in revolution speed, e.g. more than 10%, more than 20% or more than 30%, are of course likewise conceivable. In particular, the outer-circumferential speeds of the winding spool units differ at least by a larger value than the revolution speeds. In particular, an “outer-circumferential speed”, preferably a “radial outer-circumferential speed”, is to mean a movement speed and/or an angular speed of a point that is located on a radial outer surface of the respective radially outermost element from the list of winding spool unit, winding tube and filament winding package. In particular, the winding spool units comprise winding spool holders and/or winding tube holders or are preferably realized as such.

Furthermore, it is proposed that a ratio of the outer-circumferential speeds and/or of the revolution speeds of the winding spool units is selected in such a way that, when the filament is brought into contact with the free winding spool unit of the two winding spool units, which is free of filament before the transfer of the filament, a filament tension between the two winding spool units is reduced in comparison to a filament tension between the free winding spool unit and the filament-feeding device. This advantageously allows achieving simple, rapid and/or operator-independent filament transfer. Advantageously, this further enables a formation of a loop that can be captured and/or clamped by a fed-in part of the filament, so that winding onto the free winding spool unit starts automatically. In particular, as a result of the reduction of the filament tension in the region between the winding spool units, a sagging or an excess length of the filament in the region between the winding spool units is generated, thus allowing the filament to be carried along by the free winding spool unit over an outer-circumferential section of the free winding spool unit of more than 180°. In particular, due to the reduction of the filament tension in the region between the winding spool units, a total length of a section of the filament, which is not in contact with one of the winding spool units and is at the same time arranged in the region between the winding spool units, will increase to a value that is greater than a shortest distance between the winding spool units, in particular between filament contact points of the winding spool units at which the filament is respectively lifted off the winding spool units.

It is moreover proposed that during the transfer of the filament, the winding spool unit of the winding spool units that is free of filament before the transfer of the filament is operated, in particular rotated, with a greater outer-circumferential speed and/or with a greater revolution speed than the winding spool unit of the winding spool units that is already wound with a portion of the filament before the transfer of the filament. This advantageously allows achieving simple, rapid and/or operator-independent filament transfer. Advantageously, this allows achieving the reduction of the filament tension in the region between the winding spool units and/or the elongation of the filament in the region between the winding spool units.

If during the transfer of the filament a ratio of the outer-circumferential speeds and/or of the revolution speeds of the winding spool units is at least 1.01, preferably at least 1.02 and preferentially at least 1.03, it is advantageously possible to achieve an optimum reduction of filament tension and/or an optimum filament elongation in the region between the winding spool units. Larger ratios, e. g. more than 1.1, more than 1.2 or more than 1.3, are of course likewise conceivable. In principle, in certain cases a ratio >1 but <1.01 could also be sufficient for obtaining the advantageous effect (loop).

If moreover, during the transfer of the filament, a ratio of the outer-circumferential speeds and/or of the revolution speeds of the winding spool units is at most 5, preferably at most 4 and preferentially at most 3.5, advantageously an optimum reduction of filament tension and/or an optimum filament elongation are/is achievable in the region between the winding spool units. Particularly preferably, during the transfer of the filament, the ratio of the outer-circumferential speeds and/or of the revolution speeds is at most 1.3. In particular, in order to produce the revolution speed ratio and/or the outer-circumferential speed ratio, the already-wound winding spool unit is slowed down relative to the free winding spool unit.

In particular, the loop is realized as an open loop, the open side of which is oriented at least substantially pointing away from the incoming filament. In particular, the loop is initially oriented upright relative to a surface of the free winding spool unit. When the loop grows in size, it preferably falls over and then lies as a flat arc on the winding spool unit or on a winding tube placed on the winding spool unit. As a result, the loop can be captured by the incoming thread in an especially simple and/or reliable manner, in particular because it does not come to lie to the right or left of the incoming thread.

In particular, the blowing device is configured for outputting a gaseous medium, such as a blowing air or a different gaseous blowing medium, e. g. nitrogen. In particular, the spraying device is configured for outputting a liquid medium, such as for example a water or a different liquid spraying medium. It is for example conceivable that the spraying device is configured for outputting an adhesive material, which is in particular intended for a strengthening of the adherence of the filament to the free winding spool unit by adhesion, or for outputting a liquid nitrogen, which is in particular intended for a strengthening of the adherence of the filament to the free winding spool unit by freezing-on. “Configured” is in particular to mean specially programmed, designed and/or equipped. By an object being configured for a certain function is in particular to be understood that the object fulfils and/or carries out this certain function in at least one application state and/or operation state. In particular, the blowing device and/or the spraying device are/is oriented in such a way that an output direction of the blowing medium and/or of the spraying medium points at least substantially to the open side of the loop and/or points into the loop. In particular, a blowing direction/spraying direction of the blowing device/spraying device points towards the entry point of the free winding spool unit, at which the incoming filament meets the free winding spool unit. In particular, the blowing device/spraying device is arranged on a side of the filament which is situated opposite the side of the filament on which the entry point of the free winding spool unit lies. In particular, the blowing device and/or the spraying device supports the formation of the loop in that the filament, which is reduced in tension in the region between the winding spool units, is moved towards a surface of the free winding spool unit. In particular, the blowing device and/or the spraying device supports the formation of the loop in that a portion of the filament, which is reduced in tension in the region between the winding spool units, is moved more strongly towards the incoming filament than the adjoining portions of the filament, thus in particular creating a concave curvature of the filament as viewed from the blowing device and/or from the spraying device. In particular, the blowing device and/or the spraying device supports the formation of the loop in that an initially created loop is enlarged by the blowing and/or spraying. In particular, the blowing device and/or the spraying device supports the formation of the loop in that the formation of the loop is accelerated by the blowing and/or spraying.

It is further proposed that the formation of the loop is supported by a choice of a winding surface material or of a topographical winding surface property of a winding surface of the free winding spool unit, of a winding surface of a winding tube placed on the free winding spool unit or of a capturing surface of the (free) winding spool unit, in particular of a capturing ring of the (free) winding spool unit, which is arranged laterally next to the winding surface of the winding spool unit or of the winding tube. This advantageously allows attaining high reliability of the filament transfer (high “capturing rates”). Advantageously, the capturing and/or clamping of the loop by the incoming filament can be accelerated. In particular, a material with favorable adhesion properties for glass fibers, for example aluminum, hard-anodized aluminum, stainless steel, coated stainless steel, plastic or leather, is chosen as the winding surface material. In particular, a surface property with increased friction with glass fibers, for example a surface of a woven fiber glass band, a surface of a hook-and-loop ribbon, a surface of a sandpaper, a corrugated surface or an extremely smooth-polished surface, is chosen as the topographical winding surface property. In particular, the winding tube is realized as a hollow cylinder. In particular, the winding tube is configured to carry the filament and to provide it for subsequent further processing. In particular, the capturing surface is configured to provide a surface with preferably-in comparison to a surface of the already wound filament-increased friction and/or adhesion for the filament, such that a filament contacting the capturing surface is at least partially entrained with a rotation movement of the capturing surface. In particular, the capturing surface may likewise have the above-described winding surface materials and/or topographical winding surface properties. Preferably, the capturing surface is arranged between two neighboring winding tubes placed on the winding spool unit or on the further winding spool unit. In particular, the capturing surface separates two winding tubes which are arranged axially side by side on a winding spool unit. In this case, the winding spool unit in particular comprises a capturing ring, which runs around a circumference of the winding spool unit and provides the capturing surface.

If the loop extends so far towards the entry point that the loop drops under the incoming filament and is preferably clamped by the incoming filament, it is advantageously possible to achieve high reliability of the filament transfer (high “capturing rates”). In particular, firstly the loop is enlarged in an upright orientation towards the incoming filament and then tilts over in such a way that it lies as a flat arc on a winding region of the winding spool unit or of a winding tube placed on the winding spool unit, as a result of which subsequent windings of the filament run over the tilted-over arc and clamp it. In particular, the loop is clamped by the incoming filament in such a way that the loop is clamped and remains clamped also under filament windings which are formed on the winding spool unit subsequently. In particular, the loop is clamped by the incoming filament in such a way that, as a result of the rotation of the winding spool unit on which the loop is clamped, a tension is generated on the portion of the filament that is arranged in an intermediate region between the winding spool units. In particular, the loop is clamped by the incoming filament in such a way that the two winding spool units exert a tension, acting in respectively opposed directions, on the portion of the filament that is arranged between the winding spool units.

Beyond this, it is proposed that in at least one filament separation step following the filament transfer step, preferably following the clamping of the loop under the incoming filament, the transferred filament is torn apart in the intermediate region between the winding spool units, in particular on account of the different outer-circumferential speeds of the two winding spool units and/or on account of the different revolution speeds of the two winding spool units, preferably on account of the different tension directions on the filament in the intermediate region between the two winding spool units. This advantageously allows achieving particularly simple, effective and/or low-maintenance separation of the filament after completion of a filament winding package. Preferably, the tearing is effected exclusively on account of the tensile forces on the filament in the intermediate region, which are generated by the rotation of the winding spool units. Alternatively, however, it is also conceivable that the separation step is assisted by tear edges or cutting devices, which are in particular arranged in the intermediate region. Such tear edges may be provided, for example, by an, in particular S-shaped, separation plate, which is preferably arranged in the intermediate region. The cutting device could be configured for passive cutting (cutters/knives remaining unmoved in the filament separation step) or for active cutting (cutters/knives being moved in the filament separation step) of the filament in the intermediate region. In particular, cutting and/or tearing of the filament in the intermediate region will take place only when the loop has already been successfully clamped under the incoming filament, and thus in particular the filament transfer between the winding spool units (the filament transfer step) has already been realized.

Furthermore, it is proposed that during the transfer of the filament, an incoming portion of the filament or a portion of the filament that runs between the winding spool units is deflected by a pivotably and/or displaceably supported deflection and/or pressing-on element, in particular a deflection and/or pressing-on roller, in the direction of a free winding spool unit of the winding spool units, which is free of filament before the transfer of the filament. This advantageously allows attaining high reliability of the filament transfer (high “capturing rates”). Advantageously, the capturing and/or clamping of the loop by the incoming filament can be accelerated. In particular, a portion of a circumference of the free winding spool unit, which is in contact with the incoming filament, is enlarged by means of the deflection and/or pressing-on element. Preferably, the deflection and/or pressing-on element is configured to deflect the filament in such a way that at least 180°, preferably at least 190°, of an overall circumference of the free winding spool unit are in contact with the filament. Smaller or larger enlacements of the winding spool unit created by the deflection and/or pressing-on element, in particular enlacements of the free winding spool unit that are enlarged as compared to an implementation without a deflection and/or pressing-on element, are of course likewise conceivable. This advantageously allows increasing a friction and/or an adhesion of the filament with the free winding spool unit, such that in particular entrainment of the filament with the rotation movement of the free winding spool unit and/or formation of the loop and/or clamping of the loop under the incoming filament can be facilitated/achieved/improved. Herein the deflection and/or pressing-on element may be realized as a rotatable element, e.g. as a deflection roller, or as a fixed (non-rotatable) element, e.g. as a deflection rod or a deflection mat. In the case of the implementation as a fixed element, a surface of the deflection and/or pressing-on element is swept over by the filament. In the case of the implementation as a rotatable element, the deflection and/or pressing-on element at least partially co-rotates with a movement of the subsequently fed incoming filament. In particular, the deflection and/or pressing-on element that is realized as a deflection and/or pressing-on roller is free of a rotation drive of its own. In particular, a rotation axis of the deflection and/or pressing-on element realized as a deflection and/or pressing-on roller is oriented at least substantially parallel to a rotation axis of the winding spool unit. In particular, the deflection and/or pressing-on element is supported on a translating and/or pivoting device, by means of which the deflection and/or pressing-on element is introducible at least temporarily into the intermediate region between the winding spool units or into an entry region of the free winding spool unit, in which the filament is fed to the free winding spool unit. In particular, the translating and/or pivoting device comprises at least one at least pivotable and/or at least translatable support arm, on which the deflection and/or pressing-on element is mounted.

In addition, it is proposed that during the transfer of the filament, the incoming portion of the filament or the portion of the filament that runs between the winding spool units is pressed onto the free winding spool unit by a deflection and/or pressing-on element, in particular a deflection and/or pressing-on roller. This advantageously allows attaining high reliability of the filament transfer (high “capturing rates”). Advantageously, an adherence of the filament to the free winding spool unit or a friction of the filament with the free winding spool unit can be increased.

This advantageously enables execution of the filament transfer step with a particularly large number of winding tubes made of different materials, in particular also with so-called “low-friction” winding tubes having a surface made, for example, of a polytetrafluoroethylene material. Advantageously, in this way the feeding speed of a feed of the filament for the other one of the two winding spool units can be defined by the outer-circumferential speed and/or by the revolution speed of the free winding spool unit. In particular, the speed of the incoming thread is firstly defined by the winding spool unit that is already partially wound, until the free winding spool unit is in sufficient contact with the incoming filament upstream of the winding spool unit that is already partially wound, so that the free winding spool unit adopts the task of defining the entry speed. In particular, the deflection and/or pressing-on element, in particular the deflection and/or pressing-on roller, is elastically supported in such a way that a longitudinal axis, in particular a rotation axis, of the deflection and/or pressing-on element is movable in a radial direction of the winding spool unit. This advantageously allows reducing an undesired effect, like for example noise generation or loss of contact, caused by an unevenness in a winding spool surface, in a winding tube surface, for example a seam or edge, such as an injection-molded separating burr. Preferably, the winding tube which is the first to contact the incoming filament realizes a feeding device, in particular a feeding drive, for defining the feeding speed of the incoming filament and/or for generating the feeding movement of the incoming filament. Alternatively, however, filament delivery mechanisms realized and/or arranged separately from the winding tubes are also conceivable. In particular, after execution of the filament separation step, the deflection and/or pressing-on element is removed from the winding spool unit. In particular, after execution of the filament separation step, the deflection and/or pressing-on element is removed from the intermediate region between the winding spool units.

Beyond this, it is proposed that the two winding spool units are in each case eccentrically supported on a turntable that is in the filament transfer step rotated in such a way that a free winding spool unit of the winding spool units, which is free of filament before the transfer of the filament, is brought into contact with an incoming portion of the filament. This advantageously enables particularly simple and/or efficient implementation and/or execution of the filament transfer step. In particular, rotation axes of the winding spool units and of the turntable are oriented at least substantially parallel to one another. In particular, the winding spool units are arranged at least substantially opposite each other on the turntable. In particular, the winding spool units are arranged on the turntable so as to be rotated by approximately 180° around a center point of the turntable. In particular, a construction comprising the turntable and the two winding spool units is mirror-symmetrical, in particular with respect to a mirror plane within which the rotation axis of the turntable extends and which divides the turntable into two halves. However, as an alternative to an implementation with a turntable, it is also conceivable, for example, that the winding spool units are supported movably on a slot-link track having any suitable shape.

If the two winding spool units are rotated in identical and constant rotation directions during the entire filament transfer step, and preferably also during a filament separation step in which the filament is separated between the winding spool units, a particularly simple implementation of a filament winding device for the filament winding method is advantageously enabled. Advantageously, a comparatively simple drive and a comparatively simple controlling of the movement of the winding spool units are sufficient. In particular, no rotation reversal possibility is required for the rotation movements of the winding spool units. For example, the different outer-circumferential speeds and/or revolution speeds may be achieved merely by means of a slowing down or an acceleration of one of the winding spool units, in particular of the already partially wound winding spool unit, relative to the further winding spool unit.

Furthermore, the invention is based on a glass fiber winding device for filaments having a thickness of more than 300 tex, preferably for glass fiber direct rovings, in particular for carrying out the filament winding method, with the winding spool unit, with the further winding spool unit and with at least one filament transfer unit that is configured to transfer the filament that is to be wound onto the winding spool units or onto the winding tubes which are connectable to the winding spool units, from the winding spool unit to the further winding spool unit and/or vice versa, wherein the filament transfer unit is configured to operate the winding spool units with different outer-circumferential speeds and/or with different revolution speeds, at least during the transfer of the filament between the winding spool units, wherein a ratio of the outer-circumferential speeds and/or of the revolution speeds of the winding spool units can be selected in such a way that, when the filament is brought into contact with a free winding spool unit of the winding spool units which before the transfer of the filament is free of the filament, the filament forms a loop the arc of which points towards an entry point of the free winding spool unit, at which the incoming filament meets the free winding spool unit. It is proposed that the glass fiber winding device comprises a blowing device and/or a spraying device that are/is configured to assist with the formation of the loop, wherein the blowing device and/or the spraying device are/is oriented in such a way that an output direction of the blowing medium and/or of the spraying medium points at least substantially to the open side of the loop and/or points into the loop. Advantageously, production of a large number of filament winding packages can be achieved in a simple and/or efficient manner, preferably with a high piece number speed.

Furthermore, a glass fiber winding machine comprising at least one of the glass fiber winding devices, which in particular implements the advantages of the glass fiber winding device, is proposed.

Herein the glass fiber winding method according to the invention, the glass fiber winding device according to the invention and/or the glass fiber winding machine according to the invention shall not be restricted to the application and implementation described above. In particular, in order to fulfil a functionality that is described here, the glass fiber winding method according to the invention, the glass fiber winding device according to the invention and/or the glass fiber winding machine according to the invention may have a number of individual elements, components and units as well as method steps that differs from a number given here.

### DRAWINGS

Further advantages will become apparent from the following description of the drawings. Exemplary embodiments of the invention are illustrated in the drawings. The drawings, the description and the claims contain numerous features in combination. Someone skilled in the art will purposefully also consider the features individually and will find further expedient combinations.

In the drawings:

FIG. 1 shows a schematic perspective view of a portion of a filament winding machine with a filament winding device, in a first position of a filament winding method with the filament winding device,

FIG. 2 shows the filament winding device in a second position of the filament winding method, in which a filament is brought into contact with a free winding spool unit of the filament winding device,

FIG. 3 shows the filament winding device in a third position of the filament winding method, in which the filament forms a loop,

FIG. 4 shows the filament winding device in a fourth position of the filament winding method, in which the loop is captured by an incoming part of the filament,

FIG. 5 shows the filament winding device in a fifth position of the filament winding method, in which the captured filament is torn,

FIG. 6 shows the filament winding device in a sixth position of the filament winding method, in which the filament is transferred onto the free winding spool unit and is wound,

FIG. 7 shows a further schematic illustration of the filament winding device in a first state,

FIG. 8 shows the filament winding device in a second state that temporally follows the first state,

FIG. 9 shows the filament winding device in a third state that temporally follows the second state,

FIG. 10 shows the filament winding device in a fourth state that temporally follows the third state,

FIG. 11 shows the filament winding device in a fifth state that temporally follows the fourth state,

FIG. 12 shows the filament winding device in a sixth state that temporally follows the fifth state,

FIG. 13 shows the filament winding device in a seventh state that temporally follows the sixth state,

FIG. 14 shows the filament winding device in an eighth state that temporally follows the seventh state,

FIG. 15 shows the filament winding device in a ninth state that temporally follows the eighth state,

FIG. 16 shows an additional further schematic illustration of the filament winding device in an alternative first state,

FIG. 17 shows the filament winding device in an alternative second state that temporally follows the alternative first state,

FIG. 18 shows the filament winding device in an alternative third state that temporally follows the alternative second state,

FIG. 19 shows the filament winding device in an alternative fourth state that temporally follows the alternative third state,

FIG. 20 shows the filament winding device in an alternative fifth state that temporally follows the alternative fourth state,

FIG. 21 shows the filament winding device in an alternative sixth state that temporally follows the alternative fifth state,

FIG. 22 shows the filament winding device in an alternative seventh state that temporally follows the alternative sixth state, and

FIG. 23 shows a schematic flow chart of the filament winding method.

### DESCRIPTION OF THE EXEMPLARY EMBODIMENTS

FIG. 1 schematically shows a portion of a filament winding machine 58. The filament winding machine 58 is embodied as a glass fiber winding machine. The filament winding machine 58 comprises one or more filament winding devices 54.

The filament winding device 54 and/or one of the plurality of filament winding devices 54 of the filament winding machine 58 is shown by way of example in FIG. 1.

The filament winding device 54 is embodied as a glass fiber winding device. The filament winding device 54 is configured for a winding of filaments 10. The filaments 10 are realized, for example, as glass fibers. The filaments 10 are realized as glass fiber direct rovings. The filament winding device 54 is configured for a production of wound-up filament winding packages 70 (cf. also FIG. 6). The glass fiber winding device is configured for a production of wound-up glass fiber winding packages. The filament winding device 54 is configured for filaments 10 having a thickness of more than 300 tex. The filament winding device 54 is optimized for a winding and a transfer of glass fibers having a thickness between 900 tex and 10,000 tex. The filament winding device 54 is configured for an execution of a filament winding method, which is illustrated in the figures.

The filament winding device 54 comprises a winding spool unit 14. The winding spool unit 14 is supported rotatably around a rotation axis 60 which runs parallel to a longitudinal axis of the winding spool unit 14. The filament winding device 54 comprises a further winding spool unit 24. The further winding spool unit 24 is supported rotatably around a rotation axis 62 which runs parallel to a longitudinal axis of the further winding spool unit 24. The winding spool units 14, 24 are configured for a winding of the filament 10 by rotation around their rotation axes 60, 62. In the case shown, respectively two winding tubes 32 are applied on the winding spool units 14, 24. The winding tubes 32 are realized as hollow cylinders which can be plugged onto the winding spool units 14, 24. The winding tubes 32 each have a winding surface 30. The winding surfaces 30 of the winding tubes 32 are made of a winding surface material which assists with entrainment of a filament 10 that comes into contact with the winding surface 30. For example, the winding surface material of the winding tube 32 of FIG. 1 is cardboard. Alternative winding surface materials of winding tubes 32 are conceivable. Alternatively or additionally, the winding tubes 32 may respectively have a specific topographical winding surface property of the winding surface 30. The topographical winding surface property of the winding surface 30 of the winding tubes 32 is realized such that entrainment of a filament 10 that comes into contact with the winding surface 30 is assisted. For example, the winding surface 30 of the winding tube 32 of FIG. 1 has a topographical winding surface property which is characterized by special rough-ness. Alternative topographical winding surface properties of winding tubes 32 are conceivable.

The winding spool units 14, 24 comprise a capturing ring 68. The capturing ring 68 is arranged at approximately half the axial length of the respective winding spool unit 14, 24. The capturing ring 68 encompasses an entire circumference of the winding spool unit 14, 24. Respectively one winding tube 32 is arranged on the two sides of the capturing ring 68 in the axial direction of the winding spool unit 14, 24. The capturing ring 68 is arranged laterally next to the winding surface 30 of the winding tube 32. The capturing ring 68 is configured to exert a substantially increased friction or adhesion onto the filament 10 in comparison to a surface of a filament winding package 70 that is wound onto a winding spool unit 14, 24. For this purpose, the capturing ring 68 has a capturing surface 34. The capturing surface 34 of the capturing ring 68 is made of a winding surface material that assists with entrainment of a filament 10 coming into contact with the capturing surface 34. For example, the winding surface material of the capturing ring 68 of FIG. 1 is aluminum. Alternative winding surface materials of capturing rings 68 are conceivable. Alternatively or additionally, the capturing rings 68 may respectively have a specific topographical winding surface property of the capturing surface 34. The topographical winding surface property of the capturing surface 34 of the capturing ring 68 is realized in such a way that entrainment of a filament 10 coming into contact with the capturing surface 34 is assisted. For example, the capturing surface 34 of the capturing ring 68 of FIG. 1 has a topographical winding surface property which is characterized by a particularly pronounced smoothness. Alternative topographical winding surface properties of capturing rings 68 are conceivable.

The filament winding device 54 comprises a turntable 48. The turntable 48 is supported rotatably around a central rotation axis 64. The rotation axes 60, 62 of the winding spool units 14, 24 and the rotation axis 64 of the turntable 48 extend approximately parallel to one another. The turntable 48 has a transfer rotation direction 66. The turntable 48 is moved in the transfer rotation direction 66 in order to bring the filament 10 into contact with a free winding spool unit 24 of the winding spool units 14, 24. However, a rotation in a direction opposed to the transfer rotation direction 66 in sections of the filament winding method is also conceivable and possible. The winding spool units 14, 24 have rotation directions 50, 52. The two winding spool units 14, 24 are rotated during the entire filament transfer method in the rotation directions 50, 52, which are identical to one another and remain constant during the entire filament transfer method. The rotation directions 50, 52 of the winding spool units 14, 24 are opposed to the transfer rotation direction 66 of the turntable 48. The winding spool units 14, 24 are arranged eccentrically on the turntable 48. A rotation of the turntable 48 around the rotation axis 64 respectively generates a displacement of the complete winding spool units 14, 24 along circular paths.

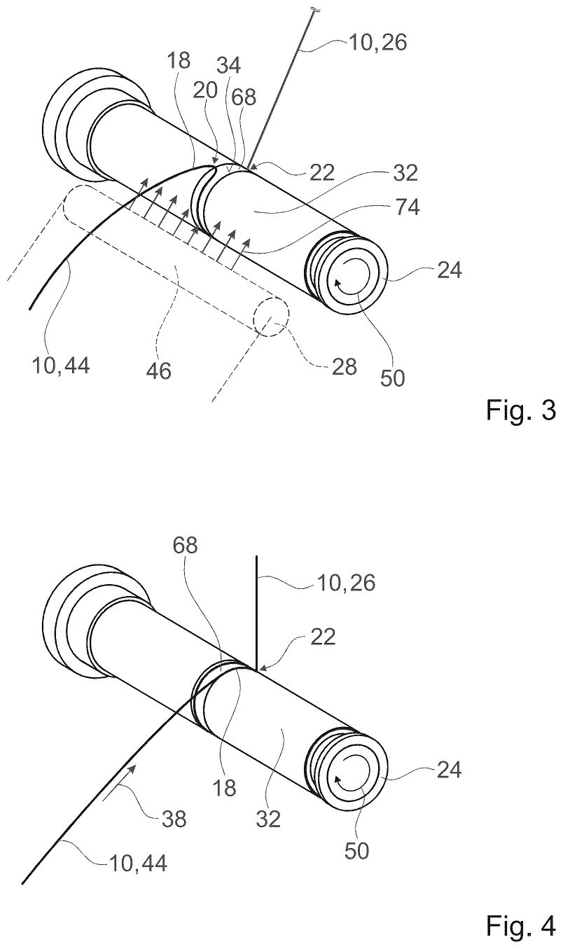

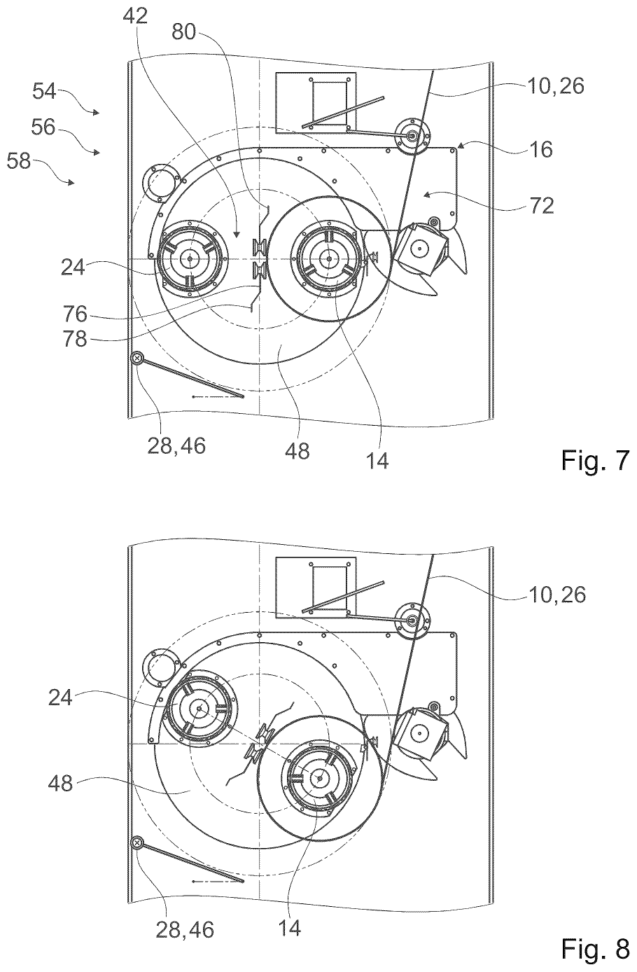

The filament winding device 54 comprises a filament transfer unit 56. The filament transfer unit 56 is configured to transfer the filament 10, which is to be wound onto the winding tubes 32 that can be connected to the winding spool units 14, 24, from the winding spool unit 14 onto the further winding spool unit 24. The filament transfer unit 56 is configured to operate the winding spool units 14, 24 with different outer-circumferential speeds and/or with different revolution speeds, at least during the transfer of the filament 10 between the winding spool units 14, 24. Herein a ratio of the outer-circumferential speeds and/or of the revolution speeds of the winding spool units 14, 24 is selected by the filament transfer unit 56 in such a way that, when the filament 10 is brought into contact with the free winding spool unit 24 of the two winding spool units 14, 24, which is free of filament 10 before the transfer of the filament 10, a filament tension between the two winding spool units 14, 24 is reduced in comparison to a filament tension between the free winding spool unit 24 and a filament feeding device 16 (cf. inter alia FIG. 7). The ratio of the outer-circumferential speeds and/or of the revolution speeds of the winding spool units 14, 24 is furthermore selected by the filament transfer unit 56 in such a way that, when the filament 10 is brought into contact with the free winding spool unit 24, the filament 10 forms a loop 18. Herein the loop 18 formed has an arc 20 pointing towards an entry point 22 of the free winding spool unit 24, at which the incoming filament 10, 26 meets the free winding spool unit 24 (cf. FIG. 3 or 4). During the transfer of the filament 10, the ratio of the outer-circumferential speeds and/or of the revolution speeds of the winding spool units 14, 24 is at least 1.01. Furthermore, during the transfer of the filament 10, the ratio of the outer-circumferential speeds and/or of the revolution speeds of the winding spool units 14, 24 is at most 3.5. For this purpose, during the transfer of the filament 10 by the filament transfer unit 56, the free winding spool unit 24 is operated with the greater outer-circumferential speed and/or with the greater revolution speed than the winding spool unit 14 that is already partially wound.

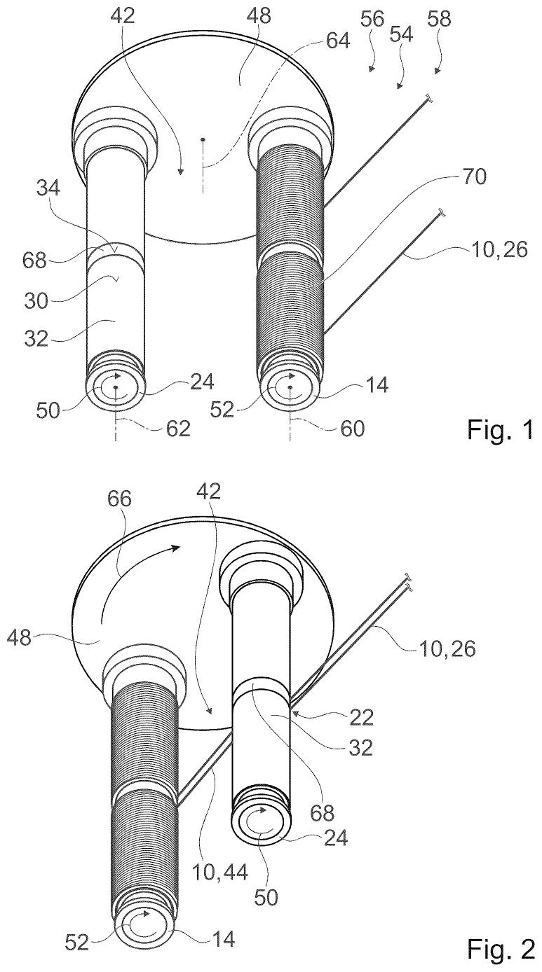

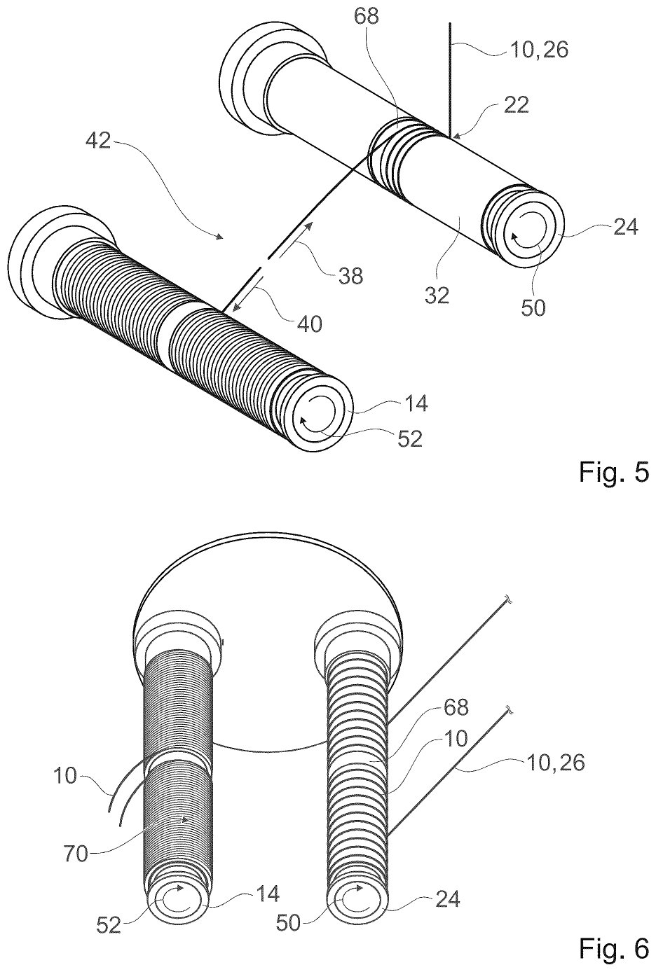

FIGS. 1 to 6 schematically show the filament winding device 54 in different time segments of the filament winding method. FIG. 1 shows the situation in which the filament winding package 70 is produced on the winding spool unit 14 by rotation of the winding spool unit 14. During the production of the filament winding package 70, the filament 10 is moved back and forth parallel to the rotation axis 60 of the winding spool unit 14 by a filament axial-guiding unit 72 (cf. inter alia FIG. 7) in order to produce a uniform winding. FIG. 2 shows the situation in which the further winding spool unit 24 is brought into contact with the filament 10 by rotation of the turntable 48 in the transfer rotation direction 66. While the winding spool units 14, 24 are being rotated by means of the turntable 48, the filament 10 is brought by the filament axial-guiding unit 72 to an axial edge region of the respective filament winding package 70, which is in particular situated closer to the capturing ring 68. FIG. 3, in which only one filament 10 is shown for the sake of clarity, shows the situation in which the loop 18 is created. FIG. 4, in which likewise only one filament 10 is shown for the sake of clarity, shows the situation in which the loop 18 has already tilted over, lies on the winding tube 32 and is captured and clamped by the incoming part of the filament 10, 26. In this way, in a tension direction 38 pointing towards the further winding spool unit 24, a tension is generated on the portion of the filament 10, 44 that is arranged in an intermediate region 42 (cf. inter alia FIG. 1) between the winding spool units 14, 24. FIG. 5, in which likewise only one filament 10 is illustrated for the sake of clarity, shows the situation in which a tension force in the tension direction 38 is increased further and further by way of winding the filament 10 onto the winding tube 32, until the portion of the filament 10, 44 that is arranged in the intermediate region 42 breaks. Herein the winding spool unit 14 generates, by its own rotation, a tension in a further tension direction 40 on the portion of the filament 10, 44 that is arranged in the intermediate region 42. The tension direction 38 and the further tension direction 40 are oriented opposed to one another. FIG. 6 shows the situation in which the filament 10 of the filament winding package 70 of the winding spool unit 14 is separated from the incoming portion of the filament 10, 26 and is wound with the filament 10 only onto the further winding spool unit 24. The filament winding package 70 can now be removed from the winding spool unit 14 and a new winding tube 32 can be placed on the winding spool unit 14, so that the steps of FIGS. 1 to 5 can be performed once again (in reverse fashion) for the (return) transfer of the filament 10 from the further winding spool unit 24 to the winding spool unit 14.

FIG. 3 shows by way of example an assisting device for assisting with the formation of the loop 18 that is important for the filament winding method. The filament winding device 54 comprises a blowing device 28. The blowing device 28 is configured for a directed output of a gas flow 74, preferably an air flow. Alternatively or additionally, the filament winding device 54 may comprise a spraying device. The spraying device may then be configured for a directed output of a liquid. The blowing device 28 and/or the spraying device are/is configured to support, in particular to accelerate, the formation of the loop 18 and/or to enlarge the extension of the loop 18 towards the entry point 22. The blowing device 28 is configured to output a gas flow 74, which is directed towards the incoming portion of the filament 10, 26. The blowing device 28 is configured to blow the gas flow 74 into an opening of the loop 18. The blowing device 28 is configured to blow the gas flow 74 onto an inner side of the arc 20 of the loop 18. The alternative or additional spraying device may have the same task and/or may have an additional task of applying an adhesion-assisting liquid on the further winding spool unit 24.

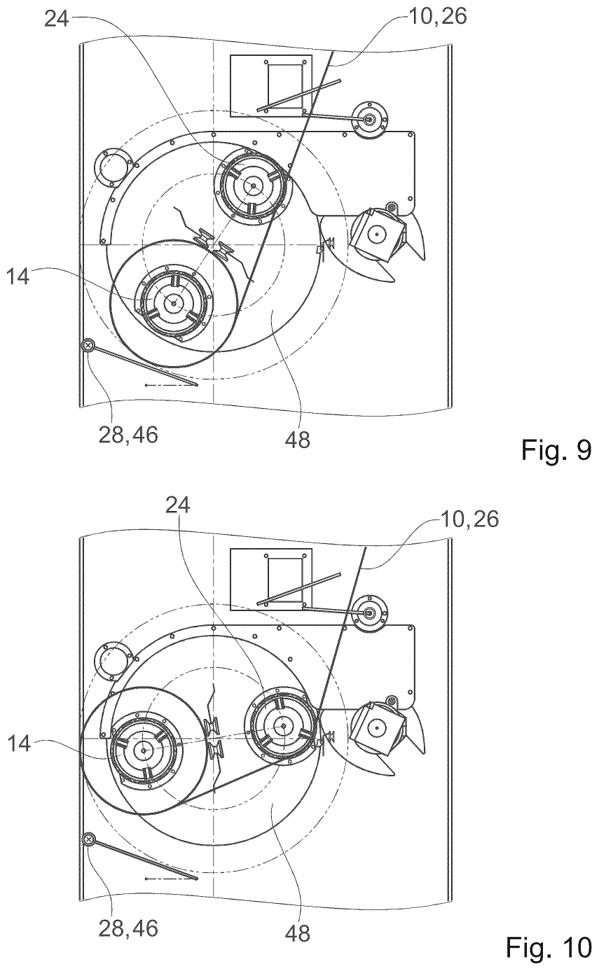

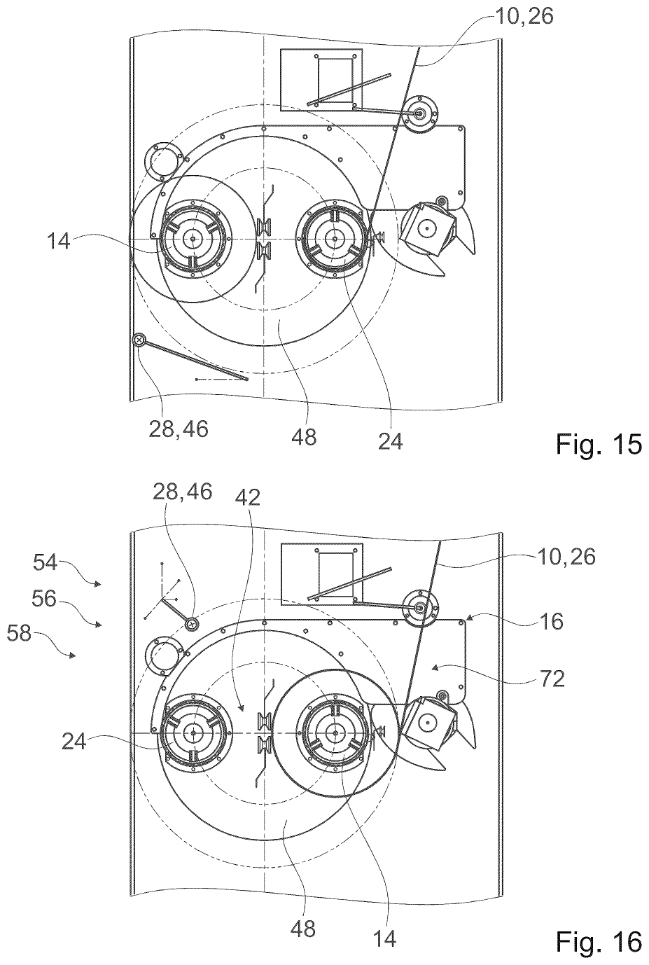

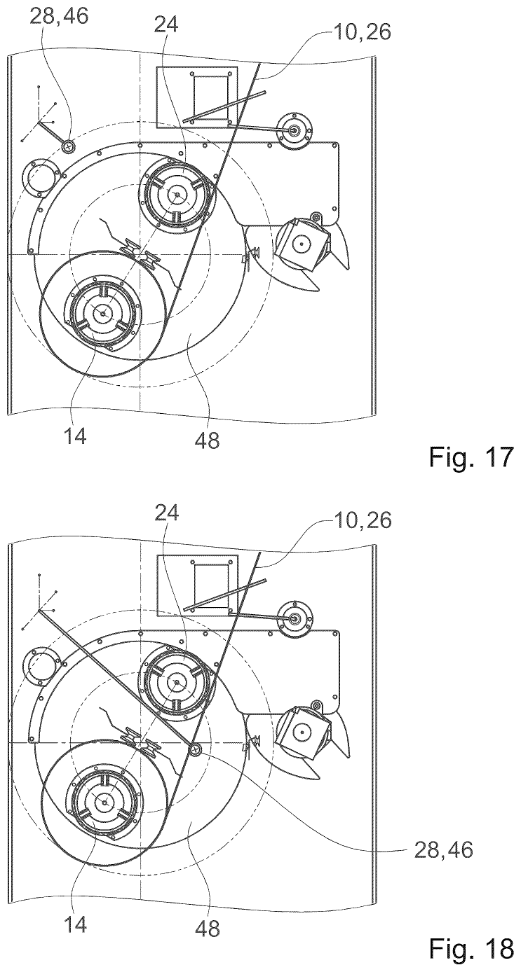

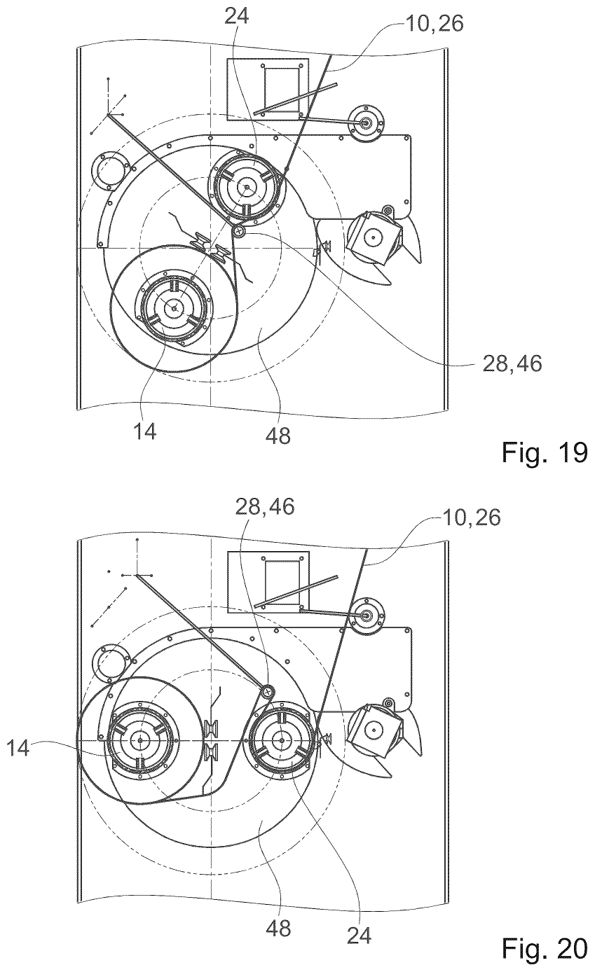

The filament winding device 54 comprises a deflection and/or pressing-on element 46. The deflection and/or pressing-on element 46 may be realized as a deflection and/or pressing-on roller. The deflection and/or pressing-on element 46 is configured, during the transfer of the filament 10, to deflect the incoming portion of the filament 10, 26 (cf. also FIGS. 7 to 15) or the portion of the filament 10, 44 that runs in the intermediate region 42 between the winding spool units 14, 24 (cf. also FIGS. 16 to 22) in the direction of the free winding spool unit 24. The deflection and/or pressing-on element 46 is configured, during the transfer of the filament 10, to enlarge an enlacement of the free winding spool unit 24 by the incoming portion of the filament 10, 26. As illustrated by way of example in FIG. 3, the deflection and/or pressing-on element 46 may be realized in a component shared with the blowing device 28 and/or with the spraying device. Alternatively, however, the deflection and/or pressing-on element 46 may also be realized as a component separate therefrom. In the example of FIG. 3, the deflection and/or pressing-on element 46 realizes only a deflection element and no pressing-on element, since it does not contact the further winding spool unit 24. However, it is also conceivable and possibly even advantageous if the deflection and/or pressing-on element 46 can be pressed onto the respective winding spool unit 14, 24, i. e. in particular contacts the further winding spool unit 24. The deflection and/or pressing-on element 46, just like the blowing device 28 and/or the spraying device, may be used alternately for the winding spool unit 14 and for the further winding spool unit 24, depending on the direction in which the filament 10 is currently transferred.

FIGS. 7 to 15 and 16 to 22 in each case schematically show a progression of the filament winding method with the filament winding device 54. The two progres-sions differ by the arrangement and movement of the pivotably and displaceably supported deflection and/or pressing-on element 46. The deflection and/or pressing-on element 46 illustrated in FIGS. 7 to 22 may further contain or realize a blowing device 28 or a spraying device. In the examples of FIGS. 7 to 22, respectively one optional tear sheet 76 is shown in the center of the turntable 48, in particular in the intermediate region 42 between the winding spool units 14, 24. The tear sheet 76 is arranged in such a way that, after successful transfer of the filament 10 to the other winding spool unit 14, 24, when the filament 10 is tensioned in the intermediate region 42 by the different tension directions 38, 40, the filament 10 tensioned in the intermediate region 42 comes into contact with a tear edge 78, 80 of the tear sheet 76, and in this way the tearing of the portion of the filament 10, 44 arranged between the winding spool units 14, 24 is assisted. It is conceivable that the tear edges 78, 80 are realized as cutters or knives.

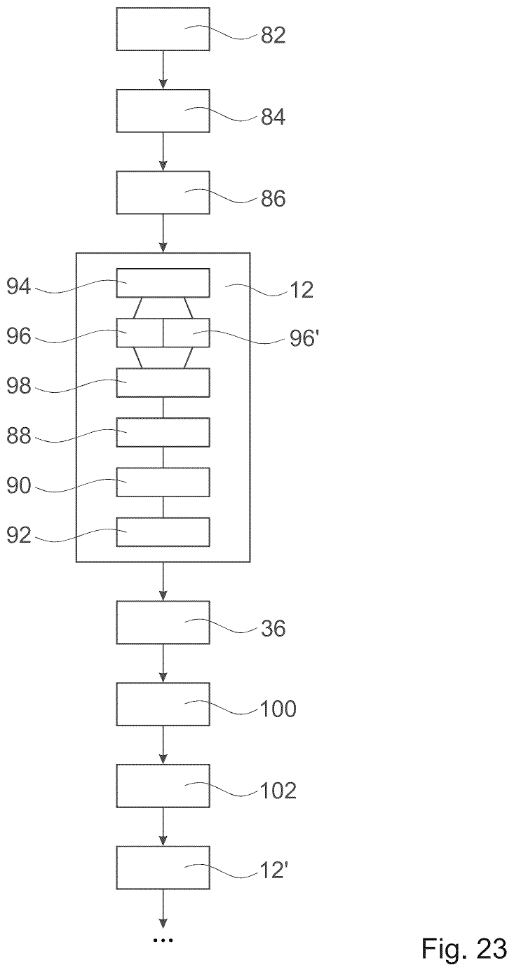

FIG. 23 shows a schematic flow chart of the filament winding method for filaments 10 having a thickness of more than 300 tex, for example glass fiber direct rovings. In at least one method step 82, filaments 10 are produced. For example, the filaments 10 are produced as glass fibers in a known manner. In at least one further method step 84, the filaments 10 are guided into the filament winding machine 58, in particular the filament winding device 54. In at least one method step 86, the filaments 10 are captured and are wound onto one of the winding spool units 14, 24, in particular onto the winding spool unit 14. In at least one filament transfer step 12, the filament 10 that is to be wound is transferred from the winding spool unit 14 onto the further winding spool unit 24. The filament winding method preferably comprises a plurality of successive filament transfer steps 12, wherein the filament 10 is transferred alternately from the winding spool unit 14 onto the further winding spool unit 24 and from the further winding spool unit 24 onto the winding spool unit 14. In the filament transfer step 12, the winding spool units 14, 24 are operated with different outer-circumferential speeds and/or with different revolution speeds, at least during the transfer of the filament 10 between the winding spool units 14, 24. Herein the ratio of the outer-circumferential speeds and/or of the revolution speeds of the winding spool units 14, 24 is selected with a value greater than 1.01 and smaller than 3.5, such that, when the filament 10 is brought into contact with the free winding spool unit 24, the filament tension between the two winding spool units 14, 24 is reduced in comparison to a filament tension between the free winding spool unit 24 and the filament-feeding device 16, as a result of which the filament 10 forms a loop 18 whose arc 20 points towards an entry point 22 of the free winding spool unit 24 (cf. FIGS. 3, 4 and 14). Herein, in the filament transfer step 12, the free winding spool unit 24 is operated with a greater outer-circumferential speed and/or with a greater revolution speed than the winding spool unit 14 that is already partially wound.

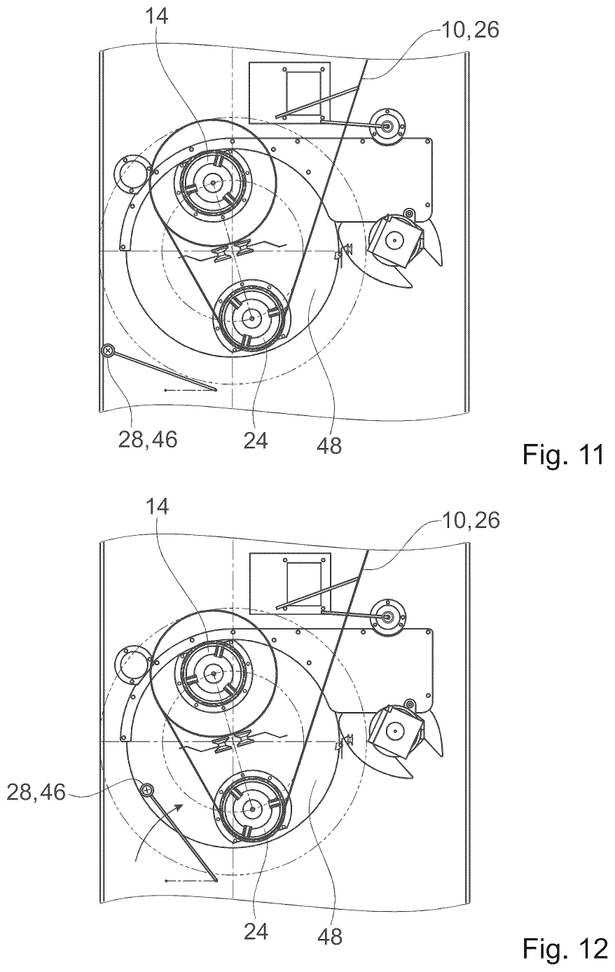

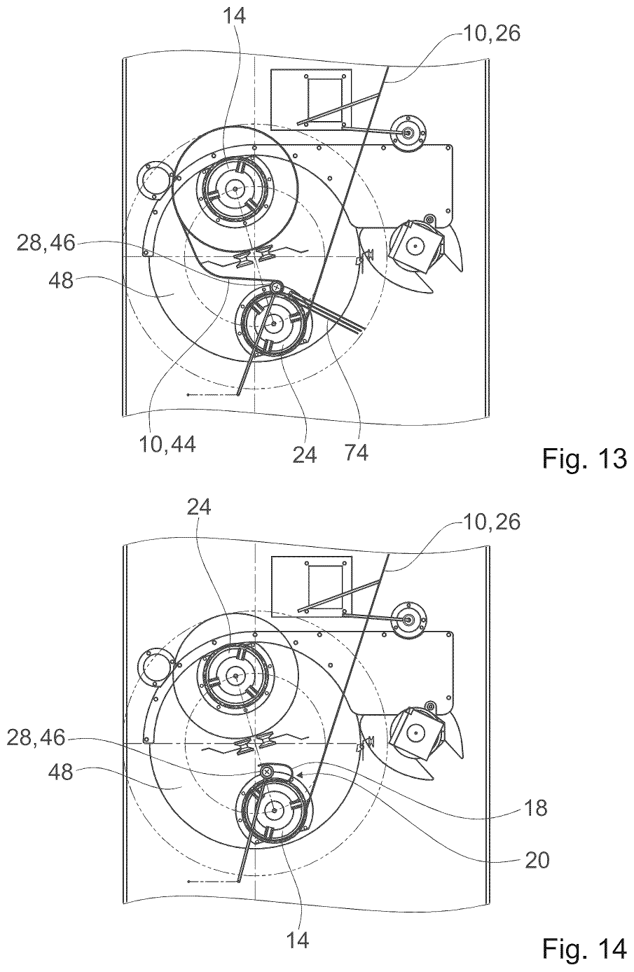

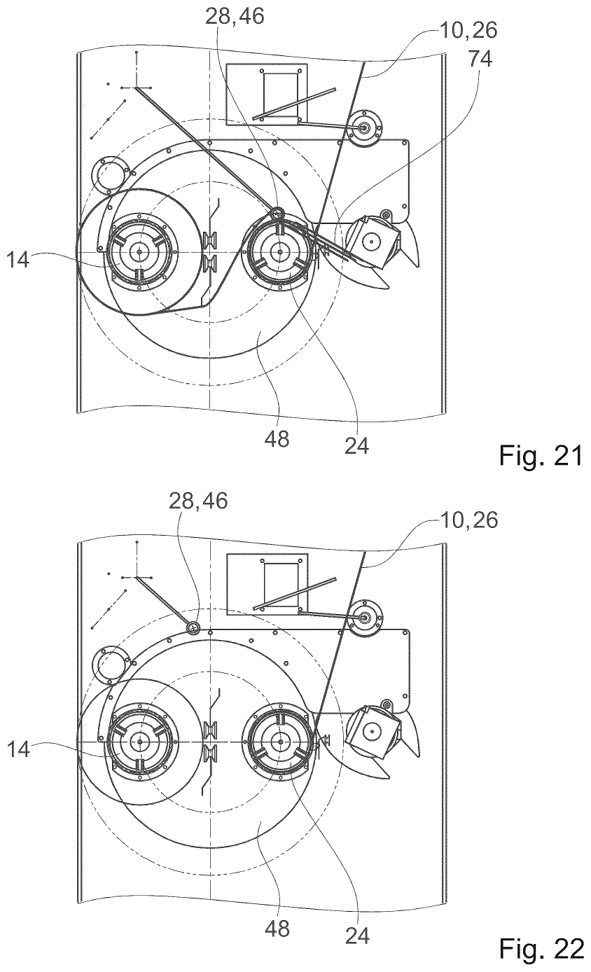

In at least one substep 94 of the filament transfer step 12, the turntable 48 is rotated in such a way that the free winding spool unit 24 is brought into contact with the incoming portion of the filament 10, 26 (cf. FIGS. 2, 9 and 19). As a result, the incoming portion of the filament 10, 26 wraps around the free winding spool unit 24 partially, but by less than 180°, in particular by less than 120° (cf. FIG. 11). In at least one further substep 96 of the filament transfer step 12, during the transfer of the filament 10, the incoming portion of the filament 10, 26 is deflected by the pivotably and/or displaceably supported deflection and/or pressing-on element 46 in the direction of the free winding spool unit 24 (cf. FIGS. 18 to 20). In at least one further substep 98 of the filament transfer step 12, during the transfer of the filament 10, the incoming portion of the filament 10, 26 is pressed onto the free winding spool unit 24 by the deflection and/or pressing-on element 46 (cf. FIG. 21). Alternatively to that, in an alternative substep 96′, it is possible that the portion of the filament 10, 44 that runs between the winding spool units 14, 24 is deflected by the deflection and/or pressing-on element 46 in the direction of the free winding spool unit 24 (cf. FIGS. 12 and 13) and is pressed onto the free winding spool unit 24 (cf. FIG. 13).

In at least one further substep 88 of the filament transfer step 12, the formation of the loop 18 is assisted by a blowing device 28 and/or by a spraying device. For this purpose, a gas flow 74 or a liquid flow is blown or sprayed onto the filament 10. In at least one further substep 90 of the filament transfer step 12, the formation of the loop 18 is assisted by an interaction of the filament 10 with a chosen winding surface material and/or a chosen topographical winding surface property of the winding surface 30 of the winding tube 32 and/or of a capturing surface 34 of the capturing ring 68. In at least one further substep 92 of the filament transfer step 12, an extension of the loop 18 is enlarged to such an extent that the loop 18 tips over and comes to lie on the winding surface 30 of the winding tube 32. In the further substep 92, the extension of the loop 18 is enlarged to such an extent that the loop 18 extends so far towards the entry point 22 that the loop 18 is clamped under the incoming filament 10, 26 by the incoming filament 10, 26.

In at least one filament separation step 36 temporally following the filament transfer step 12, the transferred filament 10 is torn apart on account of different tension directions 38, 40 on the filament 10 in the intermediate region 42 between the two winding spool units 14, 24 in the intermediate region 42 between the two winding spool units 14, 24 (cf. FIGS. 5, 15 and 22). The tearing-apart of the filament 10 may optionally be assisted by partial cutting or cutting through or guiding past tear edges 78, 80. During the filament transfer step 12 and also during the filament separation step 36, the two winding spool units 14, 24 are rotated in identical and constant rotation directions 50, 52.

In at least one further method step 100, the completely wound-up and separated filament winding packages 70 are removed from the winding spool unit 14. In case shown in the figures, each winding spool unit 14, 24 is configured to receive wo winding tubes 32 and to produce two filament winding packages 70 at the same time. However, more or fewer filament winding packages 70 per winding spool unit 14, 24 are likewise conceivable. In at least one further method step 102, new empty winding tubes 32 are applied on the winding spool unit 14. After this, a further filament transfer step 12′ will start, in which the filament 10 is transferred from the further winding spool unit 24 onto the winding spool unit 14.

1. A glass fiber winding method for filaments with a thickness of more than 300 tex, preferably for glass fiber direct rovings, with at least one filament transfer step in which the filament that is to be wound is transferred from a winding spool unit onto a further winding spool unit or vice versa, wherein the winding spool units are operated with different outer-circumferential speeds and/or with different revolution speeds at least during the transfer of the filament between the winding spool units wherein a ratio of the outer-circumferential speeds and/or of the revolution speeds of the winding spool units is selected in such a way that, when the filament is brought into contact with a free winding spool unit of the winding spool units which before the transfer of the filament is free of the filament, the filament forms a loop the arc of which points towards an entry point of the free winding spool unit, at which the incoming filament meets the free winding spool unit wherein the formation of the loop is assisted by a blowing device and/or by a spraying device, wherein the blowing device and/or the spraying device are/is oriented in such a way that an output direction of a blowing medium and/or of a spraying medium points at least substantially to the open side of the loop and/or points into the loop.

2. The glass fiber winding method according to claim 1, wherein a ratio of the outer-circumferential speeds and/or of the revolution speeds of the winding spool units is selected in such a way that, when the filament is brought into contact with the free winding spool unit of the two winding spool units which before the transfer of the filament is free of the filament, a filament tension between the two winding spool units is reduced in comparison to a filament tension between the free winding spool unit and a filament-feeding device.

3. The glass fiber winding method according to claim 1, wherein during the transfer of the filament, the winding spool unit of the winding spool units which before the transfer of the filament is free of the filament is operated with a greater outer-circumferential speed and/or with a greater revolution speed than the winding spool unit of the winding spool units which before the transfer of the filament is already wound with a portion of the filament.

4. The glass fiber winding method according to claim 1, wherein during the transfer of the filament, a ratio of the outer-circumferential speeds and/or of the revolution speeds of the winding spool units is at least 1.01.

5. The glass fiber winding method according to claim 4, wherein during the transfer of the filament, a ratio of the outer-circumferential speeds and/or of the revolution speeds of the winding spool units is at most 5.

6. The glass fiber winding method according to claim 1, wherein the formation of the loop is assisted by a choice of a winding surface material and/or of a topographical winding surface property of a winding surface of the free winding spool unit, of a winding surface of a winding tube placed on the free winding spool unit or of a capturing surface of the free winding spool unit, which capturing surface is arranged laterally next to the winding surface of the winding spool unit or of the winding tube.

7. The glass fiber winding method according to claim 1, wherein the loop extends so far towards the entry point that the loop drops under the incoming filament and is clamped by the incoming filament.

8. The glass fiber winding method according to claim 7, wherein in at least one filament separation step following the filament transfer step, the transferred filament is torn apart in the intermediate region between the two winding spool units.

9. The glass fiber winding method according to claim 1, wherein during the transfer of the filament, an incoming portion of the filament or a portion of the filament that runs between the winding spool units is deflected by a pivotably and/or displaceably supported deflection and/or pressing-on element in the direction of a free winding spool unit of the winding spool units which is free of filament before the transfer of the filament.

10. The glass fiber winding method according to claim 9, wherein during the transfer of the filament, an incoming portion of the filament or a portion of the filament that runs between the winding spool units is pressed onto a free winding spool unit of the winding spool units, which is free of filament before the transfer of the filament, by a deflection and/or pressing-on element.

11. The glass fiber winding method according to claim 1, wherein the two winding spool units are in each case eccentrically supported on a turntable that is rotated in the filament transfer step in such a way that a free winding spool unit of the winding spool units, which is free of filament before the transfer of the filament, is brought into contact with an in-coming portion of the filament.

12. The glass fiber winding method according to claim 1, wherein the two winding spool units are rotated in identical and constant rotation directions during the entire filament transfer step.

13. A glass fiber winding device for filaments having a thickness of more than 300 tex, preferably for glass fiber direct rovings, in particular for carrying out a glass fiber winding method according to claim 1, comprising:
at least one winding spool unit;
at least one further winding spool unit;
at least one filament transfer unit that is configured to transfer a filament, which is to be wound onto the winding spool units or onto winding tubes that can be connected to the winding spool units, from the winding spool unit onto the further winding spool unit or vice versa;
and a blowing device and/or a spraying device;
wherein the filament transfer unit is configured to operate the winding spool units with different outer-circumferential speeds and/or with different revolution speeds, at least during the transfer of the filament between the winding spool units, wherein a ratio of the outer-circumferential speeds and/or of the revolution speeds of the winding spool units can be selected in such a way that, when the filament is brought into contact with a free winding spool unit of the winding spool units which is free of filament before the transfer of the filament, the filament forms a loop the arc of which points towards an entry point of the free winding spool unit at which the incoming filament meets the free winding spool unit, wherein the blowing device and/or by a the spraying device that are/is configured to support the formation of the loop, wherein the blowing device and/or the spraying device are/is oriented in such a way that an output direction of a blowing medium and/or of a spraying medium points at least substantially to the open side of the loop and/or points into the loop.

14. A glass fiber winding machine comprising at least one glass fiber winding device according to claim 13.

15. The glass fiber winding method according to claim 12, wherein the two winding spool units are rotated in identical and constant rotation directions also during a filament separation step in which the filament is separated between the winding spool units.

16. The glass fiber winding method according to claim 2, wherein during the transfer of the filament, the winding spool unit of the winding spool units which before the transfer of the filament is free of the filament is operated with a greater outer-circumferential speed and/or with a greater revolution speed than the winding spool unit of the winding spool units which before the transfer of the filament is already wound with a portion of the filament.
